(19) United States
(12) Patent Application Publication
(10) Pub. No.: US 2003/0092451 A1
(43) Pub. Date: May 15, 2003

(54) Method of mobile phone consolidation

(75) Inventors: Lane Thomas Holloway, Pflugerville, TX (US); Nadeem Malik, Austin, TX (US)

Correspondence Address: Intellectual Property Law Dept., IBM Corporation, 11400 Burnet Road, Austin, TX, 78758, US

(73) Assignee: IBM Corporation, Armonk, NY

(21) Appl. No.: 09/999,142

(22) Filed: Nov. 15, 2001

(51) Int. Cl. H04Q 7/20

(52) U.S. Cl. 455/461; 455/445; 455/552

(57) ABSTRACT

Proximity of a mobile phone to a preferred phone is detected by radio frequency or Bluetooth equipped device, triggering automatic forwarding of calls for the mobile phone to the preferred telephone number. Automatic forwarding without user intervention can facilitate use of hands-free devices in vehicles and allow receipt of phone calls to mobile phone on regular lines in a home or office situation.

### BACKGROUND OF THE INVENTION

1. Technical Field

The present invention relates generally to mobile telephony, and in particular to ease of use. Still more particularly, the present invention provides a method and apparatus for automatically forwarding phone calls to a preferred second phone when the mobile phone is in the vicinity of the second phone.

2. Description of Related Art

The use of mobile phones is escalating worldwide, and as in any developing technology, new capabilities create problems that are unforeseen. For instance, the number of accidents caused by drivers using mobile phones has resulted in legislation in many states which prohibits the use of mobile phone by drivers unless they are operated hands free. While hands free operation can be achieved by an earpiece and microphone worn by the user, many persons prefer a speaker and microphone permanently installed in the vehicle, with either a docking station for their hand held mobile phone or a separate phone.

Thus, it is not uncommon for users to have a regular phone at home, a mobile phone which they carry with them, and a hands-free setup in their car. Several inconvenient or distracting situations can be caused by this proliferation of phone sites. For instance, the user may forget to use the docking mechanism in his car until a call is received or may leave the phone in the docking mechanism when they exit the vehicle. If the user has a separate phone for the car, the user may wish to receive calls on that phone when driving, and likewise to use a regular phone when at home. Therefore, it would be desirable to have this capability automatically, without requiring user intervention.

### SUMMARY OF THE INVENTION

In the disclosed invention, a low-power transmitter is used to notify a handheld mobile phone that it is in proximity to a phone whose use is preferred over that of the mobile phone itself, such as the user's home phone. When this happens, calls received by the mobile phone are automatically forwarded to the preferred phone without user intervention, and, if the mobile phone is capable of going into a standby mode, it will do so. When the user carries the mobile phone out of the vicinity of the preferred phone, the transmitter signal is lost and the forwarding function and standby mode are ended.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIGS. 1A-1B show a graphical representation of the operation of the invention in accordance with a preferred embodiment.

FIG. 2 depicts the connections between components in accordance with a preferred embodiment of the invention.

FIG. 3 shows a flowchart of events to implement an embodiment of the innovative telephone forwarding when the mobile phone is equipped with circuitry to request the forwarding.

FIG. 4 shows a block diagram of mobile phone system.

FIG. 5 depicts the connections between components in accordance with an alternative preferred embodiment of the invention.

FIG. 6 shows a flowchart of events to implement an alternative embodiment of the innovative telephone forwarding.

### DETAILED DESCRIPTION OF THE PREFERRED EMBODIMENT

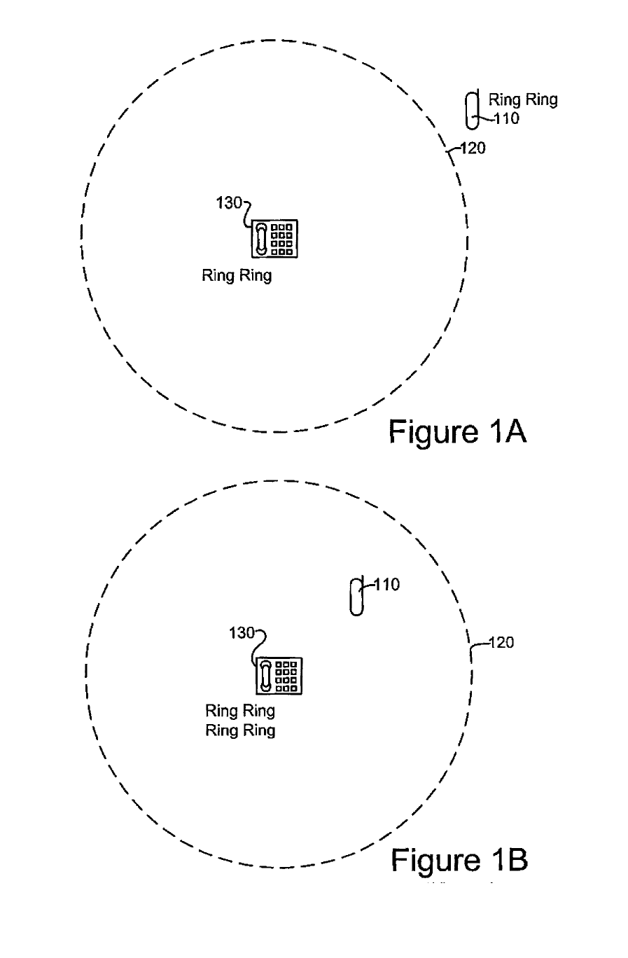

With reference now to the drawings and with particular reference to the graphical explanation of FIGS. 1A and 1B, the overall operation of the invention in accordance with a preferred embodiment will now be described. The user who carries mobile phone 110 prefers to receive calls on phone 130 whenever possible. Phone 130 can be a phone which is connected to a wire based system, e.g., at the user's home or office, or it can be a wireless phone, which is, for example, permanently installed in the user's vehicle. Phone 130 is equipped with, or has associated with it, a transmission device (not specifically shown). The range covered by the transmitter is depicted by the circle 120 which surrounds phone 130.

In FIG. 1A, when mobile phone 110 is outside the range 120 of the transmitter, each of phones 110 and 130 will receive calls sent to their own number, shown by their separate ringing. In FIG. 1B, however, mobile phone 110 has entered the range 120 of the transmitter associated with preferred phone 130, so calls to phone 110 are being forwarded to phone 130, which accepts calls for both numbers.

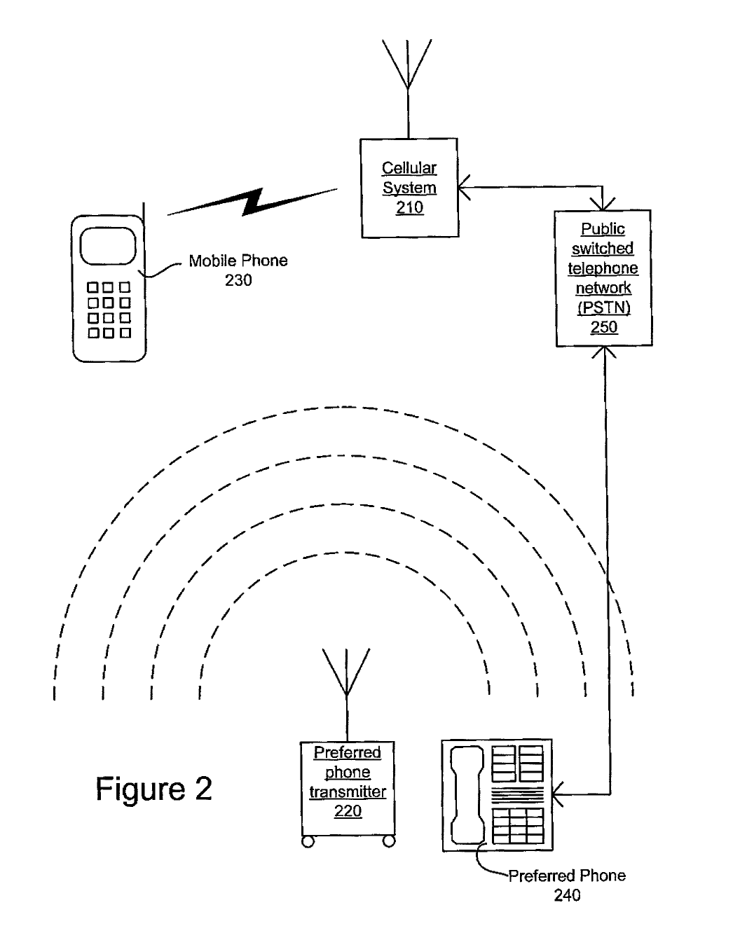

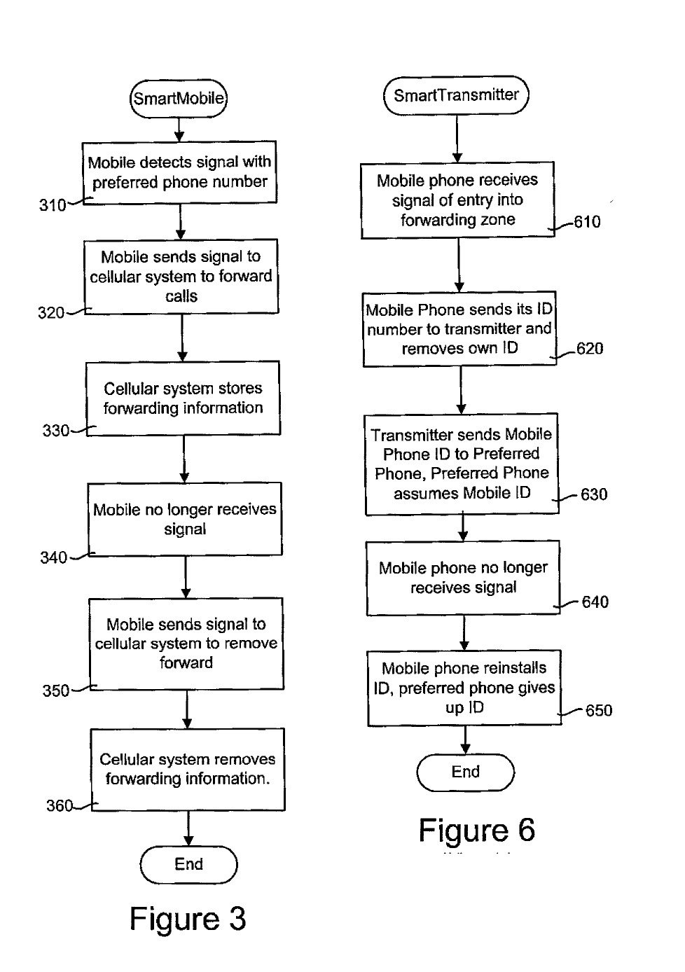

The specific protocol used to implement the system described can vary, but several exemplary methods will now be discussed. With reference to FIG. 2, an exemplary embodiment is shown in which mobile phone 230 is to be forwarded to a preferred phone 240 that is tied into the public switched telephone network (PSTN). In this embodiment, the mobile phone initiates a request to the cellular system to forward the phone. A flowchart showing the steps is shown in FIG. 3, which will be discussed at the same time as FIG. 2. Preferred phone 240 can be, for example in the user's home, an extension at an office, or anywhere the user desires. Mobile phone 230 communicates through cellular system 210, while preferred phone 240 is connected to PSTN system 250. Cellular system 210 and PSTN 250 are also connected to each other to allow communications between mobile users and PSTN users. While users are generally most familiar with the voice communications over cellular system 210 and PSTN 250, each of these systems also maintain overhead communications with their respective phones. In PSTN 250, this overhead includes monitoring whether the phone is on-hook or off-hook and handling features such as call forwarding or call waiting. Cellular system 210 likewise conducts overhead, such as locating the cell phone or passing a call off to another cell as the user travels, using separate overhead channels.

In this embodiment, transmitter 220 is a low power RF transmitter. When transmitter 220 is installed, it is programmed with the phone number of preferred phone 240. This preferred phone number is then transmitted as part of its signal. Mobile phone 230 is equipped to receive signals in the frequency of transmitter 220 and is programmed to recognize a signal meant for it. When mobile phone 230 comes within the range of transmitter 220, mobile phone 230 receives the transmitted signal (step 310). In step 320, phone 230 sends an overhead message to cellular system 210 requesting forwarding of calls to preferred phone 240 (step 320) and passing on the appropriate phone number for forwarding. Once this request is received, the cellular system stores the number for forwarding (step 330); thereafter, phone calls to phone 230 will be routed by cellular system 210 through phone system 250 to preferred phone 240. When the user carries mobile phone 230 outside of the range of transmitter 220, mobile phone 230 recognizes that it is no longer receiving a signal from the low-powered transmitter (step 340). Mobile phone 230 then transmits a request to cellular system 210 on an overhead channel to remove the forwarding request (step 350). Once cellular system 210 has removed the forwarding (step 360), the algorithm is complete.

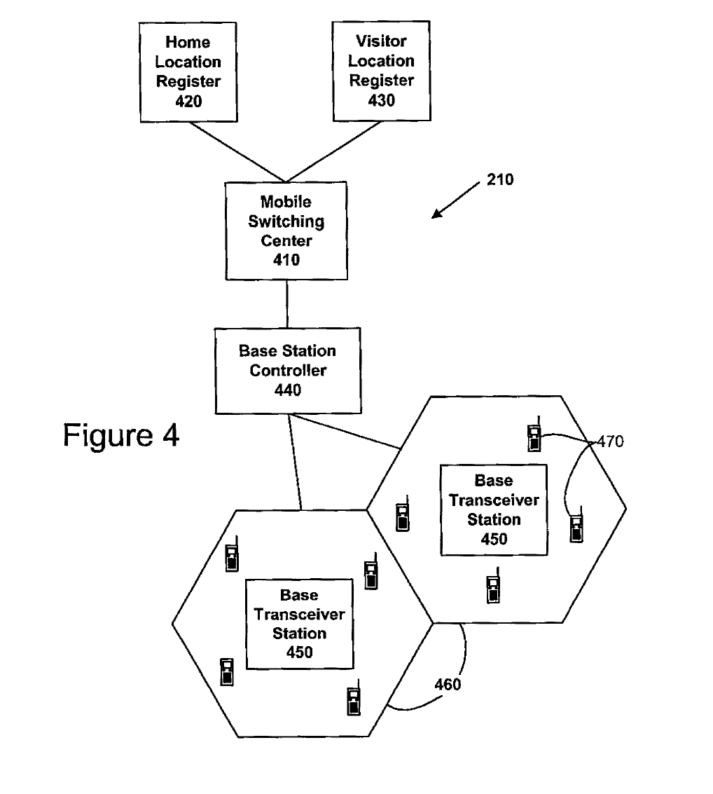

FIG. 4 is a block diagram of the cellular system 210, which was seen in FIG. 2. In cellular system 210, a mobile switching center 410 controls a region, such as a large city. Mobile switching center 410 communicates with a number of base station controllers 440, although only one is shown here. In turn, each base station controller 410 controls one or more base transceiver stations 450. Each base transceiver station 450 handles the communications with mobile phones 470 which are within the cell 460 corresponding to that base transceiver station 450. Mobile switching center 410 stores information for those phones which are enrolled in its local area in the home location register. This information can include the identification number of the mobile phone, billing information, and information regarding special services. Likewise, mobile switching center 410 stores information regarding phones which are not enrolled with it, but which are in its service area, in the visitor location register 430. Location registers 420 and 430 are used when a call is placed to a specific mobile phone. When a forwarding request is sent to a base transceiver station 450, the request and the forward-to number are passed to base station controller 440 and to mobile switching center 410. The information will be stored in the home location register 420 at the mobile switching center 410 that is “home” for that mobile phone 230. This information is referenced whenever mobile phone 230 is called so that stored forwarding information can be used.

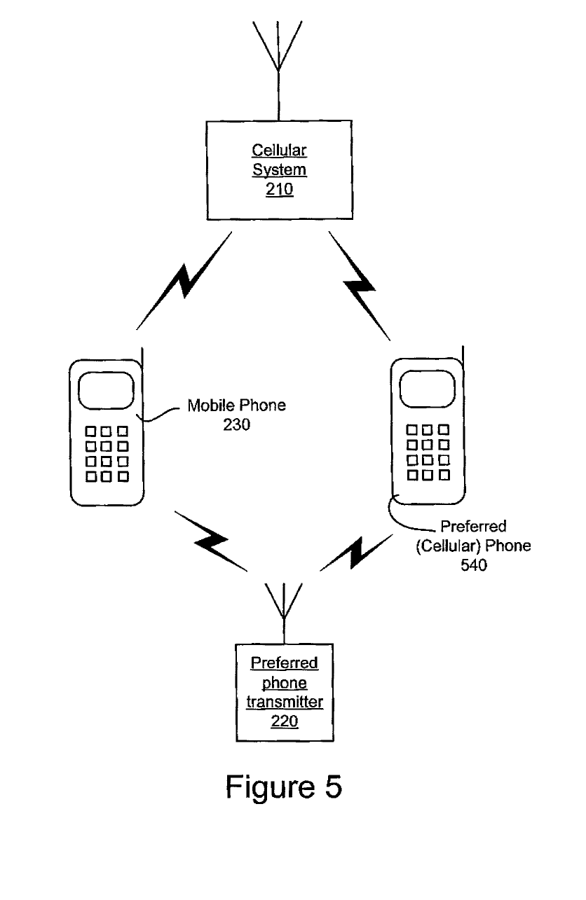

An alternate embodiment of the phone-forwarding is shown in FIG. 5, where preferred phone 540 is a hands free mobile phone installed in the user's automobile. This figure will be discussed in conjunction with FIG. 6, which explains an alternate method of handling the transfer. In this example, preferred phone transmitter 220 uses Bluetooth (TM) technology to communicate with mobile phone 230, which also includes Bluetooth capabilities. Bluetooth refers to a wireless standard which operates in the 2.4 Ghz band. Bluetooth products can have a range of 10 to 100 meter, depending on the strength of the signal, with many new applications being developed for close proximity applications, such as automatic, cordless updating between a home computer and handheld notebook.) Bluetooth does not require line of site capabilities, so mobile phone 230 can remain in a briefcase and still communicate with preferred phone transmitter 220.

In this embodiment, when mobile phone 230 is in proximity with transmitter 220 mobile phone 230 receives a signal to forward calls (step 610). The mobile phone 230 and transmitter 220, exchange a “handshake” greeting, verifying that they are intended to work together. The identity (ID) of mobile phone 230 is then passed (step 620) to preferred phone 340 with its hand-free operation, while mobile phone 230 effectively removes itself from the system and will no longer respond to calls to its ID. The ID number is then passed from transmitter 220 to preferred cellular phone 540, which installs this number as its own ID (step 630). While mobile phone 230 remains in proximity to preferred phone 340, when cellular system 210 searches for mobile phone 230, cellular system 210 finds the identity (ID) of phone 230 in preferred phone 340 and will transmit the call to phone 340. Because of the transfer of identity in this embodiment, it is important that this be a secure transmission, preferably using an encryption scheme. When the user takes mobile phone 230 out of range of transmitter 220 so that the signal is no longer received (step 640), mobile phone 230 resumes communications using its original system identity, while phone transmitter 220 passes on the message to preferred cellular phone 540 to stop responding with the transferred ID (step 650). This method can be used with phones which comply with the standards set by Global System for Mobile Communication (GSM), as well as non-GSM phones. It would be possible with this embodiment to make preferred phone 340 a phone without a system ID of its own. For instance, this arrangement would allow car rental agencies to supply hands-free capabilities to a user without incurring liability for charges to the installed phone. Rather, the hands-free phone would take on the identity of any mobile phones equipped to communicate with it.

Other capabilities can be incorporated with this application. For instance, the ability to override the transfer of calls can be programmed into a button on the mobile phone 230. This can be useful, for instance, when the preferred phone is currently engaged by another person and the user does not wish to miss calls.

Additionally, a single transmitter can be programmed to recognize different mobile phones associated with it and to transfer each mobile phone to a different extension. This could be utilized in an office where multiple employees utilize mobile phones for business or in homes where both spouses carry mobile phones.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A mobile phone comprising:
first circuitry to communicate vocally through a wireless transmission system which identifies said mobile phone by a system identifier;
second circuitry to communicate with a low-power transmitter; and
third circuitry to recognize reception of transmissions from said low-power transmitter and to forward calls directed to said mobile phone to a designated phone number.

2. The mobile phone of claim 1, wherein said second circuitry receives communications in a radio frequency range.

3. The mobile phone of claim 1, wherein said second circuitry is Bluetooth (TM) technology.

4. The mobile phone of claim 1, wherein said third circuitry receives a phone number from said transmitter and sends a request to a controlling system to forward calls for said mobile phone to said phone number.

5. The mobile phone of claim 1, wherein said third circuitry transmits its system identification in an encrypted form and nullifies its system identification while in proximity to said transmitter.

6. A low-power transmitter comprising circuitry connected to receive a number for a preferred phone to which calls are to be transferred and to communicate with a mobile phone whose calls are to be forwarded to said preferred phone number.

7. The low-power transmitter of claim 6, wherein communications with said mobile phone are uni-directional and said transmitter transmits said number of said preferred phone to said mobile phone.

8. The low-power transmitter of claim 6, wherein communications with said mobile phone are bi-directional and said mobile phone transmits a system identification to said low-power transmitter for use by said preferred phone.

9. The low-power transmitter of claim 6, wherein said transmitter operates in a radio frequency.

10. The low-power transmitter of claim 6, wherein said transmitter uses Bluetooth (TM) technology.

11. A mobile phone system, comprising:
a mobile phone transmitter configured to wirelessly communicate with a plurality of mobile phones;
a low-power transmitter configured to wirelessly communicate with one of said plurality of mobile phones;
wherein when said one of said plurality of mobile phones is within range of said low-power transmitter, calls to said one of said plurality of mobile phones are automatically forwarded to a second phone.

12. The mobile phone system of claim 11, wherein said low-power transmitter operates on a radio frequency.

13. The mobile phone system of claim 11, wherein said low-power transmitter transmits on Bluetooth (TM) technology.

14. The mobile phone system of claim 11, wherein said one of said plurality of mobile phones receives a preferred phone number from said low-power transmitter and requests said mobile phone system to forward calls to said preferred phone number.

15. The mobile phone system of claim 11, wherein said second phone is a mobile phone and said one of said plurality of mobile phones sends a system identification to said transmitter for use by said second phone.

16. A mobile phone system comprising:
Means for communicating with a plurality of mobile phones;
Means for forwarding calls to a specific one of said plurality of mobile phones when said specific one of said plurality of mobile phones is within range of a given low-power transmitter.

17. A method of handling mobile phone calls, comprising the steps of:
when a first mobile phone is within the reception area of a low-power transmitter, sending calls for said first mobile phone to a second phone; otherwise,
when said first mobile phone is not within the reception area of said low-power transmitter, sending calls for said first mobile phone to said second phone.

18. The method of claim 17, wherein said low-power transmitter utilizes Bluetooth technology.

19. The method of claim 17, wherein said low-power transmitter uses radio frequency.

20. The method of claim 17, wherein said low-power transmitter transmits a phone number for said second phone.

21. The method of claim 18, wherein said first mobile phone sends its system identification.
